(19) United States
(12) Patent Application Publication
(10) Pub. No.: US 2007/0100965 A1
(43) Pub. Date: May 3, 2007

(54) Method for selecting an additional-information by a server

(75) Inventor: Rene Schweier, Stuttgart (DE)

Correspondence Address: DREISS, FUHLENDORF, STEIMLE & BECKER, POSTFACH 10 37 62, D-70032 STUTTGART, DE

(73) Assignee: HURRA, Communications GmbH, Stuttgart (DE)

(21) Appl. No.: 11/260,368

(22) Filed: Oct. 28, 2005

(51) Int. Cl. G06F 15/16

(52) U.S. Cl. 709/218

(57) ABSTRACT

To increase the relevance of additional-information (7) that is selected by an information server (3a) and is transmitted to a client (11), the information (3a) server and the client (11) being connected to a communications network (2), with a set of additional-information (7) being assigned to the information server (3a), it is suggested that at least one predefined value is assigned to each additional-information (7), and a profile (6) is assigned to the client (11), the profile (6) comprising at least one profile-information. The method comprises the steps of determining an ordered sub-set of the set of additional-information, wherein the order of each additional-information (7) is determined depending on the value and at least one profile information, and selecting the additional-information (7) of highest order.

### BACKGROUND OF THE INVENTION

The present invention relates to a method for selecting an additional-information by a server and transmitting the additional-information to a client, wherein the server and the client are connected to a communications network, a set of additional-information being assigned to the server.

The invention also relates to a client-server system comprising a user assigned client and a server, wherein the server and the client are connected to a communications network and wherein a set of additional-information is assigned to the server.

Moreover, the invention relates to a computer program, which can be run on a client-server system, in particular on a client and/or on a server.

A multiplicity of clients and servers communicate by means of a communications network. The communications network can be realized as a computer network, such as a local area network (LAN) or a wide area network (WAN). The communications network can also be realized as a telecommunications network, e.g. a so-called cellular network. In particular, the communications network can be realized as the Internet.

The clients and the servers that communicate by means of the Internet form a multi-media information system, the so-called WWW (World Wide Web). One form of communication by means of the Internet is the transmission of so-called network pages or web pages. A server that provides information that is transmitted to a client via a network page is frequently denoted as an information server.

A network page available within the WWW can be addressed via an URL (Uniform Resource Locator). An URL enables a client to address the network page associated with the URL. For this purpose, a special computer program, a so-called browser, is executed on the client. To request a network page from an information server, a user enters the URL into a specific input field of the browser, e.g. by using a keyboard. The client subsequently generates a request to the corresponding information server. The information server then transmits the requested network page to the client. By means of the browser the transmitted network page is interpreted and displayed to the user. Therefore, a display is attached to the client.

To describe the content of a network page, the standardized page-describing language HTML (Hypertext Mark-Up Language) is mainly used today. HTML permits the description of the content and appearance of a network page within an HTML-document. If a client requests information from an information server, the information server transmits an HTML-document containing the requested information to the client.

Within an HTML-document URLs of further network pages or HTML-documents can be specified. Such an URL or at least the graphical representation of the URL within the network pate is referred to as a link. A link can be activated. If a link is displayed to a user by means of a browser, the user can activate the link, such that the network page the URL is assigned to will be displayed. It is, in particular, possible that the addressed network page resides on another information server.

An information server can be realized e.g. by a so-called web-server. A web-server is a kind of information server that provides information that can be requested via the WWW. An information server can also be realized as a so-called news server that provides the latest news, wherein the provider of a major newspaper could run the news server.

In particular, an information server can be realized as a so-called search engine. A search engine is an information server that is connected to the communications network to which the user sends a request by entering a keyword. Using predefined rules and depending on the transmitted keyword, the search engine determines information that is associated with the keyword. The search engine then causes the determined information, the so-called search result, to be transmitted to the client, e.g. by means of a network page. Frequently, the network page containing the search result is generated dynamically as an HTML-document.

Frequently, additional-information is displayed on the network page that contains the search result and is transmitted from the search engine to the client. Additional-information can be e.g. a so-called banner or advertising banner for promoting a product. The additional-information can be provided by the information server itself or by a specialized server that is run by a specialized service provider.

To select the additional-information out of a set of additional-information that is provided by the server, the content of a network page that is provided by the information server and requested by the client is conventionally evaluated. This permits categorization of the requested network page according to its content. If the set of additional-information that are stored on the server are also categorized according to the same categories, the information server can select the additional-information that matches the same category of the requested network page. This can increase the relevance of the additional-information that is included into the network page and transmitted to the client and so to a user of the client.

The selected additional-information could also be attached to the requested network page by means of a link. Activating the link by the client or the user to which the client is assigned then causes transmission of another network page from the same or another information server to the client, wherein this network page includes the additional information. If, for example, the additional-information refers to some latest news, then the link can refer to a network page provided by a news server, which contains the latest news.

The selected additional-information can further be attached by means of a link in such a way that activating the link causes execution of a computer program e.g. a so-called script that is located on the information server. A script is a succession of instructions coded in an appropriate programming language. Such a script can be realized as a pearl-script or a Java-script.

For example, a product search engine can be connected to the Internet. The product search engine allows a user to search for one or more products that can be purchased from an online shop. The product search engine therefore provides different search criteria, e.g. a range of prices, a producer or a product type. These search The user in entering appropriate keywords can specify criteria. The product search engine evaluates the keywords and transmits a result list to the client that is assigned to the user. Additionally, the product search engine could transmit additional-information. The additional-information could describe similar products, display special offers, comparisons to similar products, or accessories.

Performing a selection of additional-information increases the relevance of the additional-information transmitted to the client. Thus, the user has no need to search for this information on his own. If the user would do so, this would cause several transmissions of data between the client and one or more information servers. Therefore, selecting and transmitting an additional-information to the client can reduce the load of the communications network and the load of the information servers involved.

### SUMMARY OF THE INVENTION

It is an object of the present invention to provide a system for increasing the relevance of the additional-information transmitted to the client. Furthermore, it is an object of the present invention to reduce the usage of resources of a communications network by reducing the amount of information transmitted by means of the communications network and to reduce the workload of information servers that are connected to the communications network.

This object is solved by the method of the independent method claim. This object is also solved by the client-server system of the independent device claim.

According to the present invention, at least one predefined value is assigned to each additional-information, a profile is assigned to the client, the profile comprising at least one profile-information. The method comprises the steps of
determining an ordered sub-set of the set of additional-information, wherein the order of each additional-information is determined depending on the value and at least one profile information, and
selecting the additional-information of highest order.

The present invention allows selection of the additional-information that is likely to be of highest relevance to the user to which the client is assigned. Therefore, according to the present invention, the available additional-information is arranged in an ordered sub-set, e.g. such that only the additional-information is included into the sub-set that matches a given profile information. The order of each additional-information within the sub-set is determined at least according to the predefined value. If not, the sub-set itself is already generated using the profile information, and the order can then be determined according to the profile information. In particular, several profile information can be used for generating the sub-set as well as for determining the order of each additional-information within the sub-set. This permits selection of the additional-information independent of the content of the network page. This is, for example, particularly advantageously when the network page is a home page for which content is difficult or impossible to determine.

Several values can be assigned to each additional-information, wherein each value can also be assigned to one or more profile information. According to the given profile information, the appropriate value is selected and evaluated for determining the order of the additional-information within the sub-set. Such a value can be any value that can induce an order into the sub-set. This means, that if an order can be induced into the set of available values, then the values can also induce an order into the sub-set of additional-information. In particular, the value can be a numerical or an alphanumerical value.

Since the additional-information of highest order is selected from the sub-set of additional-information, it is likely that the selected additional-information is of highest relevance to the client or the user, in particular, if the value represents a value that defines a relevance.

Advantageously, the value defines a bid. The provider of an additional-information frequently pays a predefined amount of money to the provider of the network page, i.e. the operator of the information server that provides the network page for recall into which the additional-information is included. If the additional-information is an advertising banner, the advertiser pays the amount of money to the operator or service provider of the information server, or, for short, the information server itself, that provides the network page for recall or, in general, the information for download. Assigning a bid to the additional-information predefines the amount of money that will be paid to the information server if the additional-information is included at least as a link into the network page that is recalled by the client and thus transmitted from the information server to the client. This allows selection of the additional-information out of the sub-set of additional-information, for which the provider of the network page receives the largest amount of money when the additional-information is included into the network page.

Additionally, at least one profile information from the profile that is assigned to the client is used to select the additional-information. The relevance of the additional-information can thereby be increased, since the additional-information out of the set of additional-information can be selected that agrees with e.g. a behavior or an interest of the user to which the client is assigned.

Assuming that the provider of the additional-information bids the largest amount of money for the additional-information that is likely to be of a highest relevance to the user, this embodiment can be advantageous, since a profile-information of the client is also included in the process of selecting the additional-information.

Instead of describing an amount of money, a bid can also describe a set of points or a bonus that is attached to the provider of the network page on which the additional-information will be displayed and that can be converted into money or into a product offered by an online-shop. In particular, the bid that is assigned to each additional-information can describe any allowance that can be received by the provider of the network page and/or the web-server that caused the additional-information to be transmitted to the client.

According to an advantageous further development of the method with which the client is assigned to a user, the profile information describes a characteristic of the user. Such a characteristic of the user can, for example, be a target group to which the user belongs. Further examples are the address, the age, the gender, or the credit-worthiness of the user. This allows generation of the ordered sub-set of the set of additional-information such that the sub-set contains only additional-information that matches the characteristics of the user, wherein the characteristics are defined by the profile information.

Advantageously, the profile information describes at least one characteristic of a network page that was transmitted from a further information server to the client. This can further increase the relevance of the selected additional-information, since the characteristic of a network page previously requested by the user can be included into the selection process.

According to a preferred embodiment, the characteristic of the network page describes a topic, an origin, a length of time, an accomplished action, or a non-accomplished action.

The topic of a network page can be determined by means of a previous classification of a network page that is provided by a further information server. The origin of a transmitted network page can describe a preceding action, which released the transmission of the network page to the client. In particular, the origin can be used to determine which network page the client previously requested. If the network page was requested due to the activation of a link that was displayed on another network page, the URL of the preceding network page can be determined by means of a so-called referrer. This, in particular, enables determination of the information server, which has transmitted the preceding network page to the client. This, in turn, can be used to determine preferences of the user and thus can increase the relevance of the selected additional-information.

The length of the time describes e.g. the time between the request of the network page and the request of a further network page that is provided by the same information server or by a further information server. Knowing the length of time, it can be concluded whether the user examined the information displayed on the network page—which means that this information could, in principle, be of interest to the user—or whether the user has requested a further network page within a very short period of time—which could mean that the network page was of rather low relevance to the user.

An accomplished action can be the activation of a link that is represented on the network page transmitted to the client. Accordingly, a non-accomplished action can be the non-activation of the link that is represented on the network page. Furthermore, an action can define a summary of several sub-actions, such as purchasing or not purchasing a product, e.g. if the information server is designed as an online-shop.

These characteristics are particularly suitable to select an additional-information of high relevance to the user.

According to a preferred embodiment of the method, the profile information describes a keyword that was transmitted from the client to the information server. Advantageously, the information server is designed as a search engine, a product search engine, an online-shop, an online-forum, or a use-server.

A keyword, in particular a search string that is transmitted from the user to the information server is suitable to describe the interest of the user. Considering this kind of profile information for selecting the additional-information can significantly increase the relevance of the selected additional-information.

Preferably, a weight is assigned to the profile information and the contribution of the profile information for determining the order of the additional-information depends on the weight of the profile information. This permits several profile information to be included into the process of selecting an additional-information. For some kind of profile information it may be advantageous, if this kind of profile information has a larger effect on the selection process than another kind of profile information. For example, the keyword transmitted from the user to the second information server can be of more positive effect to the selection process than the address of the user. By assigning a weight to different kinds of profile information, the relevance of the selected additional-information can be increased. If, in another example, the age of the profile information is given, then the weight assigned to the profile information can be lower the older the profile information is.

According to another preferred embodiment, the profile is stored on a profile server and the profile server is caused to generate or update the profile by at least one of several information servers depending on a data transmission between the client and the at least one information server. The profile is thus centrally stored and administrated on and by a profile server. The profile server can be realized in software and run e.g. on the server or on any information server. The profile server can also be realized on a specialized hardware server that is connected to the communications network.

In one possible realization of this embodiment, the user recalls a network page from a first information server. The first information server then sends a message to the profile server and transmits information concerning the recalled network page, such as the content, the time of the download, etc. The network page includes a link that refers to a network page provided by a second information server. Activating the link by the user and thus by the client can start two actions.

In the first action, the linked URL is interpreted and a recall for the network page provided by the second information server is thereby transmitted to the second information server.

The second action could directly involve the profile server. This could be done by adding a second URL to the link that addresses a script located on the profile server. Activation of the link can then cause the client to also interpret the second URL and thus activate the script to be either run on the profile server or downloaded to the client and then run on the client. In particular, the script can cause the client to set a cookie, wherein the cookie can contain data that could be used as profile information. The script can also cause the client to send the profile information directly to the profile server. The script could further cause the client to send a cookie to the profile server that was previously set and that contains profile information.

Advantageously, data transmission between the client and the information server is caused by the recall of a network page provided by the information server, the purchase of a product offered by the information server, search of an information provided by the information server, search of a product provided by the information server, or registration of the user at the information server. This permits a profile of very high up-to-datedness, since several different information servers contribute to generating and updating the profile depending on several different data transmissions between the client and the information servers.

According to another preferred embodiment, the order of the additional-information within the sub-set is determined according to at least one further information.

Advantageously, the further information describes the age of the profile information, a click-through-rate that is assigned to the additional-information, a time, a time interval, an industry, a target group, a range of topics, a number of activations, a number of leads, a number of sales, or a conversion.

The click-through-rate describes how often the additional-information to which the click-through-rate is assigned was activated, relative to the number of transmissions of the additional-information to a client.

For example, the time describes a time of day or a season within which the additional-information should be selected or should not be selected. An industry, also called a branch or a sector, describes a classification regarding a business environment. This permits selection of additional-information if an industry or a range of topics that is assigned to the additional-information agrees with some kind of profile information, wherein the profile information describes interests of the user to which the client is assigned.

If the additional-information is to be displayed in the form of a link on a network page, then a number of activations can be assigned to the additional-information, wherein the number of activations defines how often the additional-information was previously activated. The number of activations can further be refined by assigning different numbers of activations to the additional-information, wherein each number of activation refers to a special characteristic of the activation, such as a predefined time interval within which the activation occurred, an identification of the information server that caused the user to activate the link, or an identification of the user or the client.

If the additional-information is provided from an information server, for example an online-shop, at which a user must register in order to request information, then it is possible to determine how often a registration has occurred without requesting any further information, in particular without purchasing a product. This is described by the number of leads.

A number of sales defines how often the transmission of the additional-information has produced a sale and/or an order of a product.

A conversion describes the relationship between the leads and the sales, wherein the leads and the sales are performed during a given time interval. One may thereby decide not to display additional-information concerning a product offered by an online-shop, if it shows a particularly high number of leads but only a very small number of sales. Such additional-information is not likely to be relevant to the user and/or the client. A representation of this additional-information on a network page would therefore most likely result in a waste of resources.

Advantageously, a weight is assigned to a further information and the contribution of the further information to the order of the additional-information depends on the weight.

According to a further preferred embodiment, the profile of the client is determined by evaluating an identification that is assigned to the client, wherein the identification is formed by means of a cookie, a unit number, a software number, or a dial-in number.

The identification makes it possible to find the profile that is assigned to the user and/or the client and to select the additional-information in dependence on the evaluation of the profile, i.e. in dependence on the evaluation of several profile information. The information server could transmit the identification to the profile server that administrates several profiles. The profile server selects the profile by means of the identification and sends the profile to the server, which then selects the additional-information depending on the received profile.

To identify the user and/or the client, the server can cause the client to set a cookie. A cookie is a set of information that will be stored in a memory assigned to the client, thereby setting the cookie. A cookie may be set automatically whenever the client activates a link that is displayed on the network page. The cookie may also be transmitted from the client to the server whenever the client requests a network page from the information server. A cookie can usually only be transmitted from the client, back to the server that has caused the client to set the cookie. In particular, profile information can be stored in a cookie.

A unit number can be the number of a network interface card. This allows a unique identification of the client. A dial-in number can be a user identification that is assigned to the user by a service provider and which is used by the user to lock-in into the communications network by means of the client. This allows assignment of a profile to the user and/or the client without knowing the real identity, e.g. the name and address, of the user. This permits maintaining the anonymity of the user and/or the client.

According to a preferred embodiment, the selected additional-information is included into a network page that is to be transmitted from the information server to the client. According to another preferred embodiment, the selected additional-information is transmitted from the server to the client independent of a recall of a network page by the client from the information server. This means, that the additional-information can be transmitted from the server to the client without any action performed by the client. This further allows transmission of the additional-information without including any information server.

The selected additional-information is advantageously transmitted from the server to the client included into an RSS-feed.

RSS is a specification language and defines a data format that allows an article or a short description of the article, e.g. a news, to be stored on an information server and to be kept available in machine-readable form. A so-called RSS-feed or news-feed consists of an XML-file, that only comprises the content i.e. the message itself, but no information concerning the layout or the design of the message. Many web-servers that regularly publish articles generate a so-called RSS-file of articles and publish this by means of RSS-feeds. With this embodiment it is possible to add additional-information to an RSS-feed that is transmitted from a web-server to a client.

The object is also achieved by a client-server system as mentioned above, wherein the client-server system is designed to execute the inventive method.

The realization of this invention in the form of a computer program is particularly important. The computer program can be run on at least one calculating device or a computer, in particular on a server and/or a client and is programmed to carry out the inventive method. Parts of the computer program may be run on different computers in order to carry out the inventive method. The invention is thereby realized by the computer program, wherein this computer program represents the invention in the same sense as the method for the execution of which the computer program is suitable. The computer program is preferably stored in a storage element. A storage element may, in particular, be a random-access-memory, a read-only-memory, a hard disk, a compact disk, or a digitally versatile disk.

### BRIEF DESCRIPTION OF THE DRAWINGS

FIG. 1 is a schematic block diagram of a client-server system in a first embodiment;

FIG. 2 is a schematic block diagram of a client-server system in a second embodiment;

FIG. 3 is a flow diagram of an embodiment of the present invention.

### DESCRIPTION OF THE PREFERRED EMBODIMENT

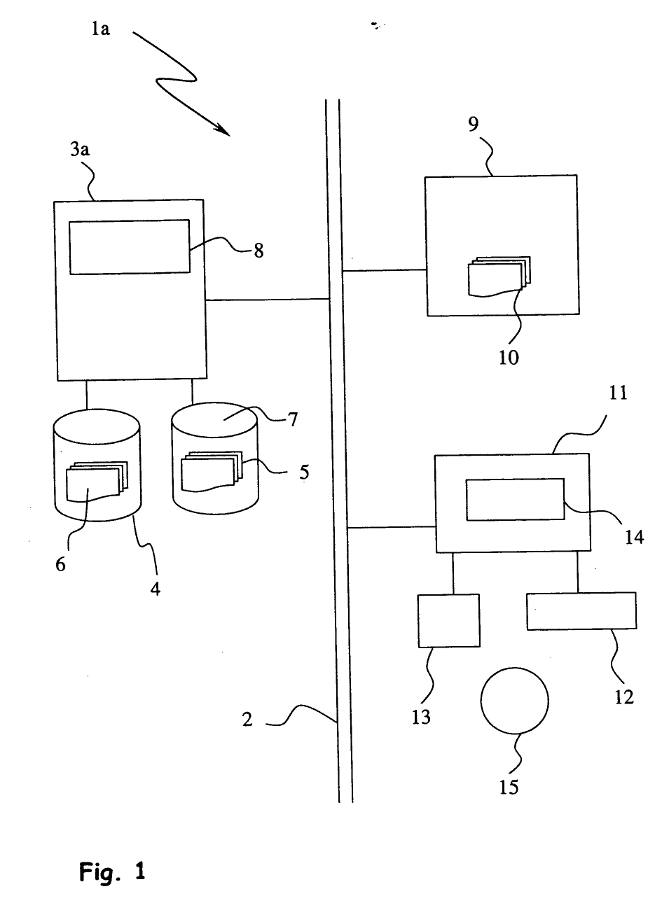

FIG. 1 shows an inventive client-server system la that is suitable to execute the inventive method. The client-server system la comprises a communications network 2, which can be realized as the Internet. The communications network 2 can also be realized as a wireless telecommunications network.

A server 3 is connected to the communications network 2. The server 3 comprises a profile database 4 and an additional-information database 5. Several profiles 6 are stored in the profile database 4. In the additional-information database 5 the set of additional-information 7 that are assigned to the server 3 are stored.

The client-server system la further comprises an information server 9. The information server 9 provides several network pages 10 for recall. The information server 9 is connected to the communications network 2.

The client-server system la further comprises a client 11. The client 11 comprises an input device 12 and a display 13. The client 11 could be realized for example as a personal computer (PC). The client 11 could also be realized as a mobile telecommunications device or as a pocket computer (PDA, hand-held). The input device 12 is for example designed as a computer keyboard, a computer mouse, a touch pad or the number keyboard of a mobile telecommunications device. The display 13 and the input device 12 are used for interaction between the client 11 and a user 15.

Computer programs are run on each component of the client-server system 1a and enable a communication between these components, in particular the server 3, the information server 9 and the client 11. A software element 14, e.g. a browser, is run on the client 11 and enables the client 11 to evaluate the input of the user 15 and to transform this input for example into the request of a network page 10. The software element 14 is subsequently also denoted as browser 14.

The browser 14 interprets a network page 10 that is received from the information server 9 via the communications network 2 to the client 11. This allows the network page 10 to be displayed on the display 13 such that it can be seen by the user 15.

A software element 8 is implemented on the server 3. The software element 8 selects the additional-information.

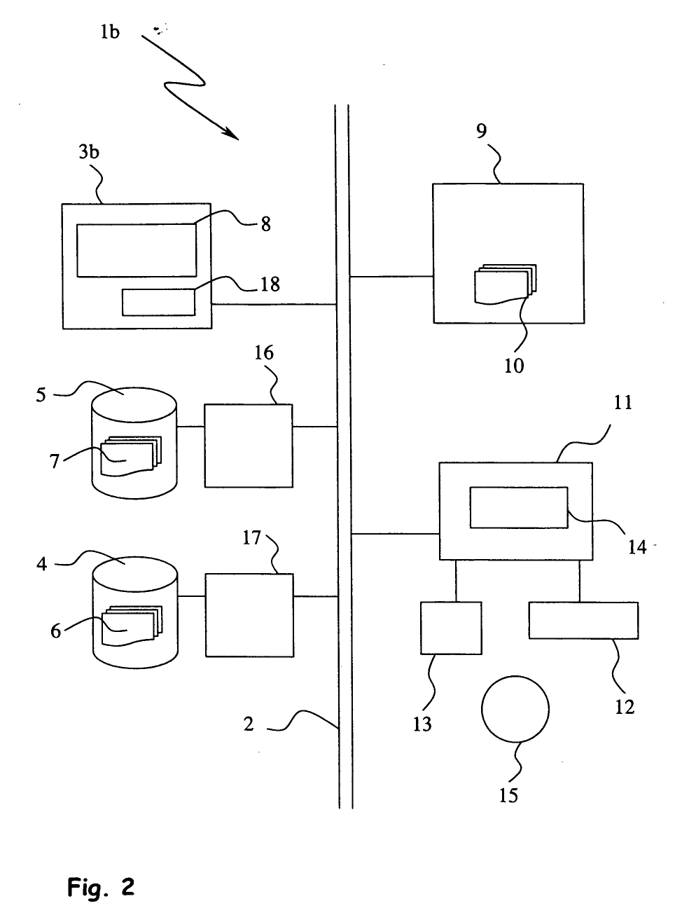

FIG. 2 shows another embodiment of the client-server system. Components of the client-server system 1b that correspond to the client-server system 1a as shown in FIG. 1 are denoted by the same reference numeral as the corresponding components.

The client-server system 1b comprises a server 3b, the information server 9 and the client 11 that are connected to the communications network 2. The client-server system 1b further comprises an additional-information server 16 and a profile server 17 that are connected to the communications network 2. The additional-information database 5 is assigned to the additional-information server 16. The profile database 4 is assigned to the profile server 17.

In the client-server system 1b, the selection of the additional-information 7 is performed by the software element 8 that is run on server 3b. The information necessary for performing the selection process, i.e. the additional-information to generate the ordered sub-set and the profiles 6 to determine the appropriate profile information, are accessed through the additional-information server 16 and the profile server 17.

The server 3b comprises a tracking system 18. So-called tracking systems are usually assigned to modern information servers 9. Such a tracking system is for example attainable via the url http://www.zanox.de or via url http://www.affilinet.de. Generally, a tracking system enables a web-server to select one or several additional-information servers 16 that provide additional-information and that are assigned to the tracking system.

Further on, the tracking system enables a web-server, e.g. the information server 9, to provide additional-information itself by storing it on the tracking system or on the server the tracking system is assigned to. The additional-information will then be presented on a network page that is transmitted from other information servers 9 to the client 11, if the other information servers 9 are registered by the tracking system. However, according to the present invention, the additional-information is only included into a network page 10 and transmitted from one of the other information servers 9 to the client 11, if it is selected according to the inventive method.

A tracking system is for example enabled to manage advertising partners of an online-shop. In this case, the additional-information are e.g. realized as advertising banners. With a tracking system, the online-shop need not possess information concerning the identity of the advertising partners. However, the tracking system will appropriately and regularly inform the online-shop about the advertising partners that are currently assigned to the online-shop. If a tracking system is assigned to the server 3b, then the information server 9 and the server 3b cause the client 11 to transmit the cookie to the server 3b, whenever the client 11 requests a network page 10 from the information server 9.

It has to be emphasized, that the components of the inventive client-server system 1a, 1b as shown in FIG. 1 and FIG. 2 are simply exemplary representations. This means in particular, that an inventive client-server system 1a, 1b can comprise many other components, as further information servers 9 of various kinds, further clients 11, and further servers 3a, 3b for selecting an additional-information. For example, the client-server system 1a, 1b can comprise a server that selects, evaluates, and updates the further information that is assigned to each additional-information. It has further to be emphasized, that due to the client-server concept, many of the functions of the present invention can be realized as a server or a client. This could be realized as a software component or as a specialized hardware component.

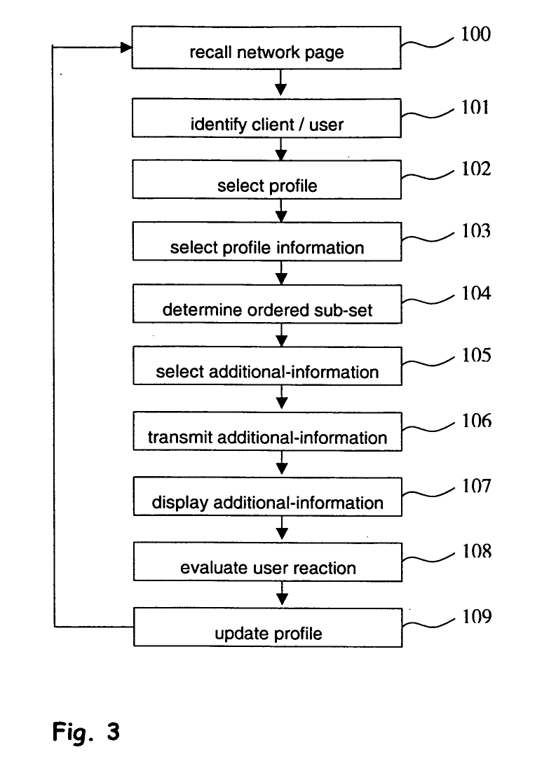

FIG. 3 shows an example of an operation method of the client-server system 1a, 1b.

The method starts with step 100, where the client 11 recalls a network page 10 from the information server 9. Therefore, the user 15 enters an URL into an input field of the browser 14. The browser 14 then causes the client 11 to send a request to the information server 9. The information server 9 can be realized as a news server, a search engine or an RSS-feed server. If the information server 9 is realized as a search engine, the request can be realized by sending a keyword that was entered by the user 15 from the client 11 to the information server 9.

In the step 101, the client and/or the user is identified. This can be effected by evaluating an identification that is automatically sent from the client 11 to the information server 9, whenever the client 11 recalls a network page 10 from the information server 9. Such an identification can be a number of the network interface card of the client 11. The identification can also be a special identification string that has to be entered by the user 15. If the client 11 is connected to the communications network 2 via a so-called service-provider and the service-provider assigns a dial-in number to the client 11, then the identification of the user and/or the client 11 can be performed by evaluating this dial-in number.

If a tracking-system 18 is attached to the server 3b, recalling the network page 10 can automatically cause the client 11 to send a cookie to the tracking system 18, wherein the tracking system 18 caused the client 11 to previously set this cookie. The server 3b that receives this cookie through the tracking system 18 can then identify the client 11 and/or the user 15.

Alternatively, the client 11 and/or the user 15 are identified by the information server 9 through an identification that is transmitted from the client 11 to the information server 9 together with the request of the network page 10. The information server 9 then sends the identification of the client 11 and/or the user 15 to the server 3a, 3b.

In step 102, the server 3a, 3b selects the profile 6 that is assigned to the client 11 and/or the user 15. Therefore, the server 3a 3b determines a request to the profile database 4. The request is automatically generated and the result of an evaluation of the identification of the client 11 and/or the user 15 is used for generating the request. The profile database 4 returns the profile 6 to the server 3a, 3b.

In step 103, the server 3a, 3b selects an appropriate profile information that is needed to determine the ordered sub-set. If the profile 6 consists only of one profile information, then the server 3a, 3b selects this profile information. If the profile 6 consists of several profile information, the server 3a, 3b selects one or more profile information according to predefined rules. This selection can be performed for example by a rule-based expert system. Such an expert system typically comprises knowledge concerning which profile information has the most significant effect on selecting additional-information of highest relevance.

For example, the expert system can select the profile information that describes the gender of the user 15 and the profile information that describes a keyword that was recently sent from the client 11 to a search engine. The expert system can further be designed to not select a profile information that describes the address of the user 15 if at least one further profile information is available.

In step 104, the ordered sub-set of the set of additional-information is determined. Therefore, the server 3a, 3b selects this additional-information out of all additional-information 7 that are stored in the additional-information database 5 to which the profile information selected in step 103 is assigned.

It is also conceivable, that in a first step, all available additional-information are included into the sub-set. In this case, the profile information would contribute to selection of the additional-information at a later stage of the selection process. This could be effected e.g. in that the profile information is weighted and the order of each additional-information 7 within the ordered sub-set is determined depending on the weight of the profile information. A value is assigned to each profile information. This value is for example a bid. The bid describes, how much the provider of the additional-information will pay to the information server 9, when the additional-information is included in a network page 10 and transmitted to the client 11. The bid can in particular describe the amount of money the provider of the additional-information 7 will pay to the information server 9, when the additional-information 7 is transmitted to the client 11 due to a request of a network page 10 from the client 11.

In general, the value that is assigned to each additional-information 7 can be any value that can induce an order into the sub-set. This means, that if an order can be induced into the set of available values, the values can also induce an order into the sub-set of additional-information 7. For example, the value can be any numerical or alphanumerical value. This means in particular, that instead of describing an amount of money, a bid can also describe a set of points or a bonus that is attached to the provider of the network page 10 on which the additional-information 7 will be displayed and that can be converted into money or into a product offered by an online-shop e.g. by another information server 9. In particular, the bid that is assigned to each additional-information 7 can describe any allowance that can be received by the provider of the network page 10 and/or the information server 9 that caused the additional-information 7 to be transmitted to the client 11.

The sub-set can also be determined depending on further information that is assigned to the additional-information 7. For example, the further information can be a time interval. If a current time is in the time interval, the additional-information 7 can be put into the sub-set. If the current time is not in the time interval, the additional-information will not be included into the sub-set. The further information can particularly describe a time, an industry, a target group, a range of topics, a number of activations, a number of leads, a number of sales, or a conversion. Whenever the further information agrees with a given characteristic, such as the current time, the branch of the information server 9, a target group to which the user 15 belongs, or a topic to which the network page 10 that is recalled from the client 11 belongs, then the additional-information is included into the sub-set.

In addition, a weight can be assigned to one or several profile information and/or to one or several further information. An additional-information 7 would then be included into the sub-set, whenever evaluation of the profile information and the further information exceeds a given value. This could also be realized by an expert system. In particular, this function could be included in the expert system already mentioned.

In step 105, the additional-information 7 is selected out of the ordered sub-set of additional-information that has the highest order. If the order corresponds to a bid, the additional-information is selected to which the highest bid is assigned. This means, that the additional-information 7 is selected for which the highest amount will be paid to the information server 9 when this additional-information is transmitted to the client 11. Other values that define the order of the sub-set are conceivable. These values can be defined, for example, according to the further information that is assigned to the additional-information 7. This means, that the value can also define a click-through-rate, a number of leads, a number of sales, or a conversion.

In a basic implementation, the server 3a, 3b will select the additional-information in step 105 that has the highest value assigned to it. In a more sophisticated implementation, weighted further values and weighted profile information are included into the selection process.

In step 106, the selected additional-information 7 is transmitted to the client 11. Therefore, the additional-information 7 can be transmitted directly from the additional-information server 16 via the communications network 2 to the client 11 or directly from the server 3a, 3b to the client 11.

The client 11 causes the selected additional-information to be transmitted to the browser 14. The browser 14 interprets the additional-information and causes the client 11 to display it on the display 13. Therefore, the browser 14 can provide a special area for displaying this kind of selected additional-information.

The selected additional-information 7 can also be transmitted from the server 3a, 3b via the communications network 2 to the information server 9. The information server 9 includes the selected additional-information 7 into the network page 10 that was requested from the client 11. The information server 9 then causes this network page 10 to be transmitted to the client 11. The client 11 receives this network page 10 and transmits it to the browser 14. The browser 14 interprets the network page 10 and causes the network page 10 to be displayed on the display 13.

It is further conceivable, that the selected additional-information 7 is transmitted to the client 11 via a so-called RSS-feed. This means that the selected additional-information 7 is transmitted to a RSS-feed server, which then incorporates the selected additional-information into a RSS-feed that has to be transmitted to the client 11. The RSS-feed server can e.g. be run on the server 3a, 3b, any information server 9, or on a specialized hardware server.

In step 107, the additional-information 7 that is received by the client 11 is displayed to the user 15, as described above.

In step 108, a user reaction is evaluated. The behavior of the user 15 is recorded and evaluated. The reaction of the user 15 can, for example, be the activating of the link, assuming that the additional-information 7 is represented by a link or that the additional-information 7 includes a link. Activating this link, can for example, cause the provider of the additional-information to transmit a network page from another information server 9 to the client 11, wherein the other information server 9 is assigned to the provider of the additional-information. This can be interpreted in that the user 15 is interested in the additional-information 7 which in turn could mean that the additional-information 7 is of high relevance to the user 15.

It also possible, that the user 15 ignores the selected additional-information 7.

In step 109, the reaction of the user 15 and/or the client 11 will be used to update the profile 6 that is assigned to the user 15 and/or the client 11. This update process ensures that the profile is highly up-to-date. This, in turn, permits selection of an additional-information 7 that is very likely to be of high relevance to the user 15.

The embodiments shown in FIGS. 1, 2 and 3 are, of course, exemplary embodiments only. In particular, it is possible to collect several steps of the method shown in FIG. 3, to interchange or delete individual steps and to change the functionality of individual steps, as long as the basic idea of the invention is realized.

Accordingly it is also possible to add several components to the client-server system 1a, 1b, as long as the basic idea of the invention is realized. In particular, it is possible to add several information servers 9, such as, for example, news servers, online-shops, tracking-systems, or servers 3a, 3b for selecting additional-information. In particular, it is possible to implement each server 3a, 3b and each information server 9 as a software component or as a hardware component. This means, in particular, that several servers 3a, 3b and several information servers 9 can be implemented on the same hardware.

I claim:

1. A method for selecting additional-information by an information server and transmitting the additional-information to a client, wherein the information server and the client are connected to a communications network, a set of additional-information being assigned to the information server, wherein at least one predefined value is assigned to each additional-information and a profile is assigned to the client, the profile having at least one profile-information, the method comprising the steps of:
a) determining an ordered sub-set of the set of additional-information, wherein an order of each additional-information is determined depending on a value and at least one profile information; and
b) selecting the additional-information of highest order.

2. The method of claim 1, wherein the value defines a bid.

3. The method of claim 1, wherein the client is assigned to a user and the profile information describes a characteristic of the user.

4. The method of claim 1, wherein the profile information describes at least one characteristic of a network page that was transmitted from a second information server to the client.

5. The method of claim 4, wherein the characteristic of the network page describes a range of topics, an origin, a length of time, an accomplished action, or a non-accomplished action.

6. The method of claim 1, wherein the profile information describes a key word that was transmitted from the client to a second information server.

7. The method of claim 6, wherein the second information server is designed as a search engine, a product search engine, an online-shop, an online-forum, or a news-server.

8. The method of claim 1, wherein a weight is assigned to the profile information and the contribution of the profile information to determining the order of the additional-information depends on its weight.

9. The method of claim 1, wherein the profile is stored on a profile server and the profile server is caused to generate or update the profile by at least one of several information servers depending on a data transmission between the client and the at least one information server.

10. The method of claim 1, wherein data transmission between the client and the information server is caused by recall of a network page provided by the information server, purchase of a product offered by the information server, search of an information provided by the information server, search of a product provided by the information server, or registration of the user at the information server.

11. The method of claim 1, wherein the order is determined according to at least one further information assigned to each additional-information.

12. The method of claim 11, wherein the further information describes an age of the profile information, a click-through-rate that is assigned to the additional-information, a time, a time interval, an industry, a target group, a range of topics, a number of activations, a number of leads, a number of sales, or a conversion.

13. The method of claim 11, wherein a weight is assigned to the further information and the contribution of the further information to the order depends on the weight.

14. The method of claim 1, wherein the profile of the client is determined by evaluating an identification that is assigned to the client, wherein the identification is defined by means of a cookie, a unit number, a software number, or a dial-in number.

15. The method of claim 1, wherein the selected additional-information is included into a network page that is to be transmitted from a second information server to the client.

16. The method of claim 1, wherein the selected additional-information is transmitted from the information server to the client independent of a recall of a network page by the client from a second information server.

17. The method of claim 1, wherein the selected additional-information is transmitted from the information server to the client as an RSS-feed.

18. The method of claim 1, wherein the client comprises a software element, the selected additional-information being transmitted to the software element via the communications network, wherein the software element effects representation of the additional-information.

19. A client-server system having a user assigned client and an information server, wherein the information server and the client are connected to a communications network, wherein a set of additional-information is assigned to the information server, the system comprising:
means for assigning at least one characteristic to each additional-information;
means for assigning a profile to the client, the profile having at least one profile-information;
means for determining an ordered sub-set of the set of additional-information, wherein an order of each additional-information depends on at least one profile information; and
means for selecting additional-information of highest order out of the ordered sub-set.

20. The client-server system of claim 19, wherein the order corresponds to a bid.

21. The client-server system of claim 19, wherein the client is assigned to a user and the profile information describes a characteristic of the user.

22. The client-server system of claim 19, wherein the profile information describes a key word that was transmitted from the client to a second information server.

23. The client-server system of claim 19, wherein the profile information describes at least one characteristic of a network page that was transmitted from a second information server to the client.

24. The client-server system of claim 23, wherein the characteristic of the network page describes a range of topics, an origin, a length of time, an accomplished action, or a non-accomplished action.

25. The client-server system of claim 22 or 23, wherein the second information server is designed as a search engine, a product search engine, an online-shop, an online-forum, or a news-server.

26. The client-server system of claim 19, wherein the client-server system comprises a profile server for storing the profile and several information servers, wherein the information servers comprise means for causing the profile server to generate and/or update the profile depending on a data transmission between the client and the information server.

27. The client-server system of claim 26, wherein data transmission between the client and the information server are caused by recall of a network page provided by the information server, purchase of a product offered by the information server, search of an information provided by the information server, search of a product provided by the information server, or registration of the user at the information server.

28. The client-server system of claim 19, wherein a weight is assigned to the profile information and a contribution of the profile information to determining the order of the additional-information depends on its weight.

29. The client-server system of claim 19, wherein at least one further information is assigned to each additional information, wherein the client-server system comprises means to determine the order according to the at least one further information.

30. The client-server system of claim 29, wherein the further information describes the age of the profile information, a click-through rate that is assigned to the additional information, a time, a time interval, an industry, a target group, a range of topics, a number of activations, a number of leads, a number of sales, or a conversion.

31. The client-server system of claim 29, wherein the client-server system comprises means for assigning a weight to the further information, wherein the contribution of the further information to the order depends on the weight.

32. The client-server system of claim 19, wherein an identification is assigned to the client and the client-server system comprises means for selecting the profile by evaluating the identification, wherein the identification is defined by means of a cookie, a unit number, a software number, or a dial-in number.

33. The client-server system of claim 19, wherein the client-server system comprises means for including the selected additional-information into a network page and means for transmitting the network pate from a second information server to the client.

34. The client-server system of claim 19, wherein the client-server system comprises means for transmitting the selected additional-information from the information server to the client independent of a recall of a network page by the client from a second information server.

35. The client-server system of claim 19, wherein the client-server system comprises means for transmitting the selected additional-information to the client as an RSS-feed.

36. The client-server system of claim 19, wherein the client comprises a software element and the client-server system comprises means for transmitting the selected additional-information to the software element via the communications network, wherein the software element comprises means for representing the additional-information.

37. A computer program, which can be run on a client-server system on a client and/or on a server, wherein the computer program is programmed to execute the method of claim 1.

38. The computer program of claim 37, wherein the computer program is stored on a memory element, wherein the memory element is a disk, a compact disk (CD), a digitally versatile disk (DVD), and/or at least one part of a RAM or a ROM that is assigned to the client-server system.
